(19) United States
(12) Patent Application Publication
(10) Pub. No.: US 2024/0275176 A1
(43) Pub. Date: Aug. 15, 2024

(54) POWER CONVERSION SYSTEM FOR CONNECTING PHOTOVOLTAIC PLANT TO ELECTRIC GRID

(71) Applicant: Huawei Digital Power Technologies Co., Ltd., Shenzhen (CN)

(72) Inventors: Sebastian Rosado, Nuremberg (DE); Piniwan Thiwanka Bandara Wijekoon, Nuremberg (DE)

(21) Appl. No.: 18/642,308

(22) Filed: Apr. 22, 2024

Related U.S. Application Data
(63) Continuation of application No. PCT/EP2021/079179, filed on Oct. 21, 2021.

(51) Int. Cl. H02J 3/38; H02M 1/00; H02M 7/49

(52) U.S. Cl. CPC H02J 3/381; H02M 1/007; H02M 7/49; H02J 2300/26; H02J 2300/28

(57) ABSTRACT

A power conversion system includes one or more solid state transformers, and a medium voltage DC-AC inverter. Each solid state transformer includes a primary stage, including at least one DC-AC converter, each arranged to receive low voltage DC power from a power generation unit, and one or more primary medium frequency transformer windings, and a secondary stage, including at least one AC-DC rectifier, each arranged to receive AC power from a respective secondary medium frequency transformer winding. The medium voltage DC-AC inverter is configured to receive medium voltage DC power from one or more rectifiers and output medium voltage AC power.

### CROSS-REFERENCE TO RELATED APPLICATIONS

This application is a continuation of International Application No. PCT/EP2021/079179, filed on Oct. 21, 2021, the disclosure of which is hereby incorporated by reference in its entirety.

### FIELD

The present disclosure relates generally to a power conversion system, and describes a power conversion system for connecting a photovoltaic plant to an electric grid. This allows large amounts of photovoltaic plant generated power to the electric grid providing higher power density with improved functionality and flexibility on power conversion stages.

### BACKGROUND

A solar photovoltaic (PV) plant is a large-scale photovoltaic system that supplies power into an electric grid with energy generated by solar panels or PV panels. In the solar PV plant, connecting the energy generated to the electric grid is necessary to direct the generated energy and power to customers. The energy from the solar panels or the PV panels is generated at a variable Direct Current (DC) voltage. The DC voltage energy is converted to a higher, less variable DC voltage that is more suitable to be conditioned for a grid connection. Normally, the DC voltage energy is fed into Maximum Power Point Tracker (MPPT) boxes for DC conditioning. In order for the energy to be fed into the Alternating Current (AC) high voltage grid, the power (i.e. Conditioned DC power or energy) from the MPPT boxes is converted from DC to AC, and the voltage may be increased for long-distance transmission. The solar PV plant provides the functionality of conversion from DC to AC and voltage transformation. The voltage transformation and voltage level rise are done by using solid state transformers (SST) that operate at frequencies higher than standard grid line frequencies. While operating at higher frequencies, SSTs can transform more power with fewer amounts of materials, i.e. higher power density.

FIG. 1 is a block diagram of a power conversion system 100 for connecting a photovoltaic plant to a grid in accordance with an implementation of the prior art. The power conversion system 100 includes a group of PV module arrays 102A-N, one or more combiner boxes 104A-N that collect power from the group of PV module arrays 102A-N, and a central DC-AC inverter 106, and a power transformer 108. The one or more combiner boxes 104A-N are connected to the central DC-AC inverter 106 that could reach the power of several hundred kilowatts (KWs) to a few megawatts (MWs), e.g. 4 MW. The number of cables used can be reduced with the one or more combiner boxes 104A-N, but a cross-sectional area of conductors is not reduced as DC voltage is same. The central DC-AC inverter 106 is connected to the power transformer 108 where the voltage is raised to medium voltage (MV) and connected to a MV AC network. The central DC-AC inverter 106 and the power transformer 108 can be an AC power block and a utility-scale PV plant includes several AC power blocks. The power conversion system 100 lacks flexibility and inability to optimize the energy production from the group of PV module arrays 102A-N. The one or more combiner boxes 104A-N for DC are expensive and incurs in large installation cost for the central DC-AC inverter 106 and its connection to the MV grid.

Mostly, the central DC-AC inverter 106 includes a string inverter-based architecture. The string inverter-based architecture eliminates one or more combiner boxes 104A-N and has the flexibility to optimize the energy production from each array of the group of PV module arrays 102A-N. The optimization of the energy production is achieved by providing MPPT in the group of PV module arrays 102A-N i.e. ideally one MPPT per PV module array. In addition, the mounting of DC-AC string inverters (i.e. DC-AC array inverters) is simpler and implying a lower cost, that a group of string inverters feeds the power to the power transformer 108 that elevates the voltage to MV and connects to the MV grid. The string inverter-based architecture requires a large amount of low voltage cable, transformer, and related connection, and protection of the string inverter-based architecture is based on classical AC grid equipment.

Existing solutions connecting the utility scale PV plant to the electric grid requires a large amount of Low Voltage (LV) cables at a maximum voltage of 1500V requiring large cross sectional area of a conductor in transformers, and DC/AC inverters for converting the generated DC power from PV arrays to AC line. The DC/AC inverters are located close to the MPPTs or in central location close to a low frequency transformer that the low voltage circulates by relatively larger magnitude currents. A low frequency power transformer is required for LV to MV transformation. The existing solutions including the low frequency power transformer are a bulky component employing large amounts of copper and silicon-iron (Si—Fe) and also requires additional construction costs. In addition, LV and MV connection and protection equipment, e.g. circuit breakers, disconnectors, switch gears are also bulky components with additional works/cost required for installation and maintenance.

The voltage regulation made by on-load tap changers (OLTC) has a response time in order of seconds, thereby the associate controls are usually of slow performance. The protection equipment also has slow reaction times due to mechanical actuation, thereby large stresses in case of faults. The size and efficiency of utility scale power plants have increased with a development of PV technology, which enables requiring of power levels to be aggregated in a single point of grid connection is also larger, and new utility scale PV plants do not able to inject larger amounts of power at increased voltage levels.

Therefore, there arises a need to address the aforementioned technical problem/drawbacks in the power conversion system connecting the photovoltaic (PV) plant generated power to the electric grid, which allows large amounts of PV generated power to the electric grid.

### SUMMARY

The present disclosure describes a power conversion system for connecting a photovoltaic plant to an electric grid while avoiding one or more disadvantages of prior art approaches.

The present disclosure provides a power conversion system for connecting the photovoltaic plant to the electric grid, which allows large amounts of photovoltaic plant generated power to the electric grid, providing higher power density with improved functionality and flexibility on power conversion stages.

According to a first aspect, there is provided a power conversion system. The power conversion system includes one or more solid-state transformers and a medium voltage DC-AC inverter. Each solid-state transformer includes a primary stage and a secondary stage. The primary stage includes at least one DC-AC converter, each arranged to receive low voltage DC power from a power generation unit, and one or more primary medium frequency transformer windings. The secondary stage includes at least one AC-DC rectifier, each arranged to receive AC power from a respective secondary medium frequency transformer winding. The medium voltage DC-AC inverter is configured to receive medium voltage DC power from one or more AC-DC rectifiers and output medium voltage AC power.

The power conversion system is a compact system with lower installation and maintenance costs. Equipment cost of the power conversion system is low due to reduced use of expensive conductor material, for example, copper. The power conversion system enables better functionality and flexibility due to control of power over conversion stages. The power conversion system in a utility-scale photovoltaic plant provides a higher power density for electric equipment. The power conversion system achieves a higher power density based on higher voltages and lower currents for the same power transferred to the grid using the one or more solid-state transformers and the Medium Voltage (MV) DC-AC inverter. The power conversion system enables fast protection against fault over currents and isolation capability of the power conversion due to the smaller sizing of the one or more solid state transformers. The power conversion system protects against fault over currents at a higher speed by reducing peak current values and a time of exposure to large currents. The power conversion system provides a higher degree of modularity and flexibility, and making an electrical architecture of the power conversion system more versatile.

The one or more solid state transformers provide galvanic isolation between the MVDC and Low Voltage (LV) DC, and improves an electromagnetic compatibility of the system. The one or more solid state transformers increases safety in an operation of the power conversion system, and an electromagnetic compatibility and immunity of photovoltaic fields provide fast reaction capabilities. The one or more solid state transformers provide protection and disconnection in case of events of faults, thereby enabling quicker disconnection and quick response to transient disturbances. The one or more solid state transformers provide control and regulation functions for an efficient function of the power conversion system. The one or more solid state transformers including a magnetic component may be smaller in size than a low frequency AC power transformer due to a use of medium frequency power conversion in a range of several kilohertz (KHz). Power levels aggregated using this power conversion system may reach several tens of MWs. The protection by the one or more solid state transformers can be realized at a much higher speed than one in classical low-frequency AC equipment.

By including the one or more solid-state transformers and the MV DC-AC inverter there is a drastic reduction of expensive conductor material, like copper. Due to the drastic reduction of the expensive conductor material, and as the peak magnetic flux in a transformer is inversely proportional to the frequency of operation, the one or more solid state transformers operate in a medium frequency range in the range of several kHz, thereby downsizing the magnetic cores significantly.

In an embodiment, the secondary stage of each solid state transformer is configured to output low voltage DC power, and an output of each of the AC-DC rectifiers in the one or more solid state transformers is connected in series. In an embodiment, the summed output voltage of the AC-DC rectifiers is a medium voltage in a range of 20-50 kV.

In an embodiment, the secondary stage of each solid state transformer is configured to output the medium voltage DC power, and an output of each of the AC-DC rectifiers in the one or more solid state transformers is connected in parallel.

In an embodiment, the low voltage DC power is less than about 1500V.

In an embodiment, each primary medium frequency transformer winding is connected to two DC-AC converters in a bipolar configuration.

In an embodiment, the power conversion system further includes one or more maximum power point trackers (MPPT) configured to connect each power generation unit to the corresponding DC-AC converter.

In an embodiment, each power generation unit is a photovoltaic unit, or a wind power generation unit.

In an embodiment, the medium frequency transformer windings of the solid state transformers are configured to operate at a medium frequency in a range of 2-20 KHz.

In an embodiment, one or more rectifiers are active or passive rectifiers.

The secondary stage of the one or more solid-state transformers includes AC-DC rectifiers. The AC-DC rectifiers are passive rectifiers that reduce a substantial cost over an option with active power semiconductors, thereby providing a simplified control and inherent higher ruggedness of diodes may also contribute to cost reduction.

In an embodiment, the medium voltage DC-AC inverter is a modular multilevel converter or a voltage source converter.

In an embodiment, the medium voltage DC-AC inverter is configured to output medium voltage AC at a low frequency in a range of 50-60 Hz.

In an embodiment, the power conversion system further includes a low-frequency transformer configured to receive medium voltage AC power from the medium voltage DC-AC inverter and output high voltage AC power for supply to an electric grid.

In an embodiment, the low-frequency transformer is integrated with the medium voltage DC-AC inverter by combining one or more branch inductors in the medium voltage DC-AC inverter with one or more windings of the low-frequency transformer.

The integration of MV to HV transformers to a modular multi-level converter (MMC) potentially reduces the amount of magnetics used in the power conversion system. The one or more solid state transformers windings are replaced by the one or more branch inductors to avoid leakage produced by the windings. The stresses over the one or more solid state transformers windings may still increase but the benefit of integrating the MV to HV transformer is larger than the size needed to meet the increased requirements.

Therefore, in contradiction to the existing conventional solutions, the power conversion system described herein enables converting power for connecting the photovoltaic plant to the electric grid. The power conversion system enables receiving a low voltage power from a power generation unit to output a medium voltage AC power. The power conversion system converts the DC power using one or more solid state transformers and a medium voltage DC-AC inverter to achieve lower installation, maintenance, and lower equipment cost due to reduced use of expensive conductor material.

These and other aspects of the present disclosure will be apparent from description below.

### BRIEF DESCRIPTION OF DRAWINGS

Implementations of the disclosure will now be described, by way of example only, with reference to the accompanying drawings, in which:

FIG. 1 is a block diagram of a power conversion system for connecting a photovoltaic plant to a grid in accordance with an implementation of the prior art;

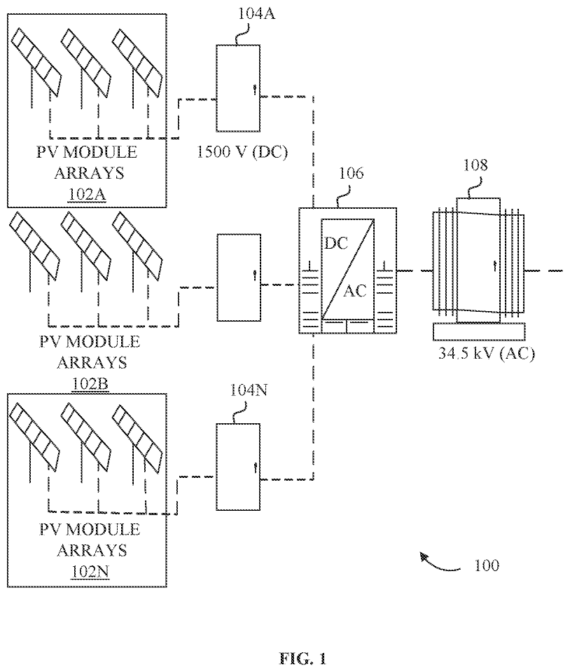

FIG. 2 is a block diagram of a power conversion system in accordance with an implementation of the disclosure;

FIG. 3 is a schematic diagram of a power conversion system for connecting a photovoltaic plant to an electric grid in accordance with an implementation of the disclosure;

FIG. 4 is an exemplary diagram of a power conversion system with one or more solid state transformers connected together with one or more Maximum Power Point Trackers (MPPT) DC-AC converters in accordance with an implementation of the disclosure;

FIG. 5 is an exemplary diagram of a power conversion system with a voltage source converter in accordance with an implementation of the disclosure;

FIG. 6 is an exemplary diagram of a power conversion system integrated with a Medium Voltage (MV) to High Voltage (HV) transformer in accordance with an implementation of the disclosure; and

FIG. 7 is an exemplary diagram of a power conversion system with one or more solid state transformers that employs a passive rectifier in accordance with an implementation of the disclosure.

### DETAILED DESCRIPTION OF THE DRAWINGS

The present disclosure describes a power conversion system that enables converting power for connecting a photovoltaic plant to an electric grid that provides higher power density with improved functionality and flexibility on power conversion stages.

To provide more clarity to the present disclosure for a person skilled in the art, the following embodiments of the present disclosure are described with reference to the accompanying drawings.

Terms such as “a first”, “a second”, “a third”, and “a fourth” (if any) in the summary, claims, and foregoing accompanying drawings of the present disclosure are used to distinguish between similar objects and are not necessarily used to describe a specific sequence or order. It should be understood that the terms so used are interchangeable under appropriate circumstances and that the embodiments of the present disclosure described herein are, for example, capable of being implemented in sequences other than the sequences illustrated or described herein. Furthermore, the terms “include” and “have” and any variations thereof are intended to cover a non-exclusive inclusion. For example, a process, a method, a system, a product, or a device that includes a series of steps or units is not necessarily limited to expressly listed steps or units but may include other steps or units that are not expressly listed or that are inherent to such process, method, product, or device.

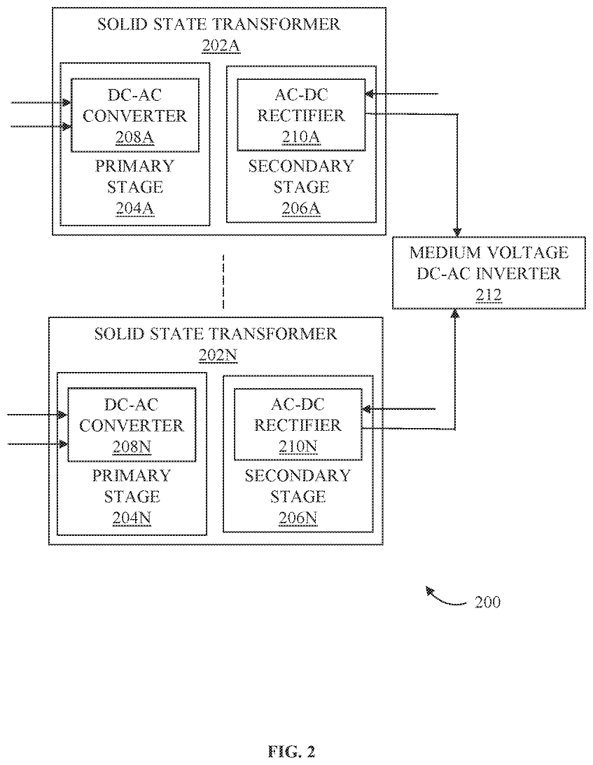

FIG. 2 is a block diagram of a power conversion system 200 in accordance with an embodiment of the disclosure. The power conversion system 200 includes one or more solid-state transformers 202A-N and a medium voltage Direct Current (DC)-Alternating Current (AC) inverter 212. Each solid-state transformer 202A-N includes a primary stage including at least one DC-AC converter 208A-N, each arranged to receive a low voltage DC power from a power generation unit, and one or more primary medium frequency transformer windings, and a secondary stage including at least one AC-DC rectifier 210A-N, each arranged to receive AC power from a respective secondary medium frequency transformer winding. The medium voltage DC-AC inverter 212 is configured to receive medium voltage DC power from one or more AC-DC rectifiers 210A-N and output medium voltage AC power.

The power conversion system 200 is a compact system with lower installation and maintenance. Equipment cost of the power conversion system 200 is low due to the reduced use of expensive conductor material, for example, copper. The power conversion system 200 enables better functionality and flexibility due to control of power over conversion stages. The power conversion system 200 in a utility-scale photovoltaic plant provides a higher power density for electric equipment. The power conversion system 200 achieves a higher power density based on higher voltages and lower currents for the same power transferred to an electric grid using the one or more solid-state transformers 202A-N and the medium voltage DC-AC inverter 212. The power conversion system 200 enables fast protection against fault over currents and isolation capability of the power conversion due to the smaller sizing of the one or more solid-state transformers 202A-N. The power conversion system 200 protects against fault over currents at a higher speed by reducing the peak current values and the time of exposure to large currents. The power conversion system 200 provides a higher degree of modularity and flexibility thereby making an electrical architecture of the power conversion system 200 more versatile.

The power conversion system 200 may collect electric energy as DC from a set of distributed energy sources and inject electric power into the electric grid. The electric grid may be an electric utility grid. The distributed energy sources may be one or more batteries or fuel cells, power generation units (also referred to herein as a power generator), and the like. The power generation unit may be a photovoltaic unit (also referred to herein as a photovoltaic power generator) or a wind power generation unit (also referred to herein as a wind power generator). In an embodiment, the power conversion system 200 receives low voltage DC power from the power generation unit and the one or more primary medium frequency transformer windings. In an embodiment, the power conversion system 200 receives AC power from the one or more secondary medium frequency transformer windings. The power conversion system 200 including the one or more solid state transformers 202A-N is configured to regulate voltage and current of the DC power and the AC power. In an embodiment, the one or more solid state transformers 202A-N is an AC-to-AC converter.

The one or more solid state transformers 202A-N including a solid state transformer 202A includes a primary stage 204A and a secondary stage 206A. The primary stage 204A including a DC-AC converter 208A is configured to receive the low voltage DC power from the power generation unit, and one or more primary medium frequency transformer windings. The secondary stage 206A including an AC-DC rectifier 210A is configured to receive the AC power from the respective secondary medium frequency transformer windings.

The power conversion system 200 including the medium voltage DC-AC inverter 212 is configured to convert DC power to AC power. The medium voltage DC-AC inverter 212 may convert the DC power that is the collected electric energy from the set of distributed energy sources into the AC power. In an embodiment, the medium voltage DC-AC inverter 212 receives the medium voltage DC power from the one or more DC-AC rectifiers 210A-N of the one or more solid state transformers 202A-N and outputs medium voltage AC power.

The power conversion system 200 converts the DC power into a higher voltage level collecting ring with the one or more solid state transformers 202A-N. In an embodiment, a secondary side of the one or more solid state transformers 202A-N is connected in series to obtain a larger DC voltage. The DC power from the medium voltage ring may be converted into the AC power with the medium voltage DC-AC inverter 212. In an embodiment, the medium voltage DC-AC inverter 212 is connected to an AC transformer that increases the voltage to the electric grid.

In an embodiment, the secondary stage of each solid state transformer is configured to output low voltage DC power, and an output of each of the AC-DC rectifiers in the one or more solid state transformers 202A-N is connected in series.

In an embodiment, the summed output voltage of the AC-DC rectifiers is a medium voltage in a range of 20-50 kV.

In an embodiment, the secondary stage of each solid state transformer is configured to output medium voltage DC power, and an output of each of the AC-DC rectifiers in the one or more solid state transformers 202A-N is connected in parallel. In an embodiment, the low voltage DC power is less than about 1500V.

In an embodiment, each primary medium frequency transformer winding is connected to two DC-AC converters in a bipolar configuration.

In an embodiment, the medium frequency transformer windings of the one or more solid state transformers 202A-N are configured to operate at a medium frequency in a range of 2-20 kHz.

In an embodiment, the AC-DC rectifiers are active or passive rectifiers.

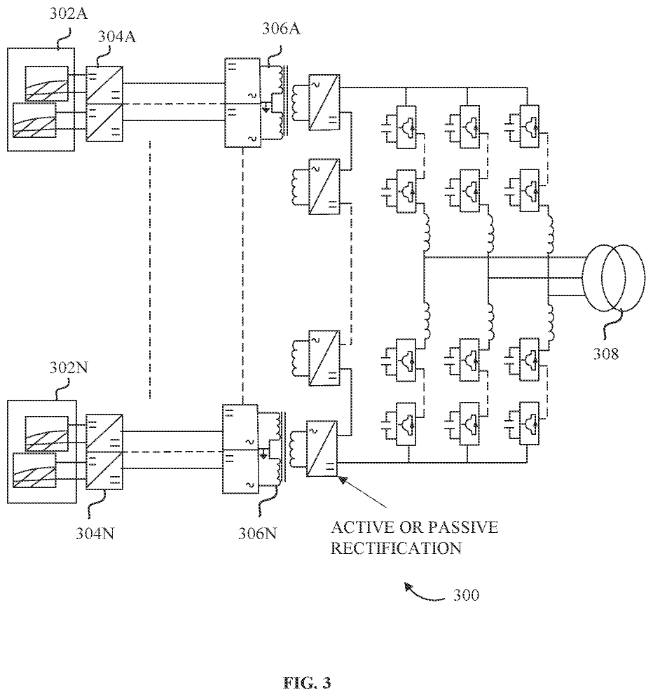

FIG. 3 is a schematic diagram of a power conversion system 300 for connecting a photovoltaic plant to an electric grid in accordance with an embodiment of the present disclosure. The schematic diagram of the power conversion system 300 includes one or more photovoltaic units 302A-N, one or more Maximum Power Point Trackers (MPPTs) 304A-N, one or more solid-state transformers 306A-N, and an electric grid 308. In an embodiment, the power conversion system 300 including the one or more Maximum Power Point Trackers (MPPTs) 304A-N is configured to connect each power generation unit to a corresponding DC-AC converter. In an embodiment, the one or more MPPTs 304A-N is a MPPT DC-DC converter. In an embodiment, each power generation unit is a photovoltaic unit, or a wind power generation unit. The one or more MPPTs 304A-N may be connected at strings of the power generation unit. In an embodiment, the one or more MPPTs 304A-N is connected at strings of photovoltaic panels. The photovoltaic panels may be in the one or more photovoltaic units 302A-N. In an embodiment, the one or more MPPTs 304A-N may handle low voltage DC power. The low voltage DC power may be less than 1500V.

The low voltage DC power is directed to the one or more solid state transformers 306A-N through cables using a Low Voltage Direct Current (LVDC) connection. In an embodiment, the LVDC connection uses a bipolar configuration using +/−1500 Voltage DC.

In an embodiment, the one or more solid state transformers 306A-N convert the low voltage DC power to Medium Voltage (MV) DC power. A primary stage of the one or more solid state transformers 306A-N are connected to various DC sources and a secondary stage of the one or more solid state transformers 306A-N are connected in series. The one or more solid state transformers 306A-N connected in series in the secondary stage may create a MV DC system with voltage in Kilovolts, for example, in a range of 20-30 KVs. The power conversion system 300 converts the MV DC power in to AC power to inject to the electric grid 308. In an embodiment, the power conversion system 300 converts the MV DC power in to the AC power with a MV DC-AC inverter. The MV DC-AC inverter may be a multi-level converter. The MV DC power is converted to the AC power using active or passive rectification and is injected into the electric grid 308 using a MV DC-AC inverter. In an embodiment, the power conversion system 300 includes a standard low frequency MV/HV transformer that connects the DC power to the electric grid 308.

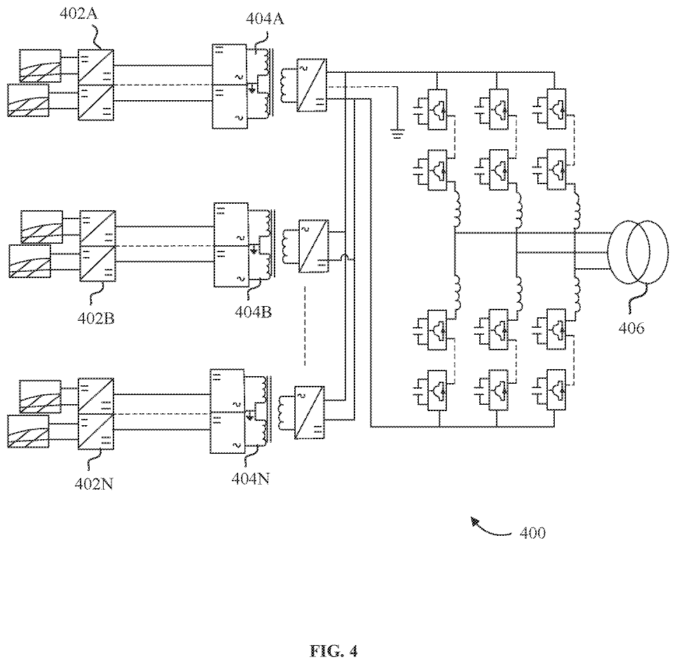

FIG. 4 is an exemplary diagram of a power conversion system 400 with one or more solid state transformers 404A-N connected together with one or more Maximum Power Point Trackers (MPPT) DC-AC converters 402A-N in accordance with an embodiment of the present disclosure. The exemplary diagram of the power conversion system 400 includes the one or more MPPT DC-AC converters 402A-N, the one or more solid state transformers 404A-N, and a bulk DC to AC converter interconnecting an electric grid 406. The one or more solid state transformers 404A-N are placed close to the one or more MPPT DC-AC converters 402A-N at photovoltaic strings. In an embodiment, the one or more MPPT DC-AC converters 402A-N connect with the one or more solid-state transformers 404A-N without Low Voltage (LV) DC cables.

The power conversion system 400 depicted in FIG. 4 reduces or eliminates a usage of LVDC cables connecting the one or more MPPT DC-AC converters 402A-N to the one or more solid state transformers 404A-N. The power conversion system 400 reduces an amount of conductor material, for example, copper.

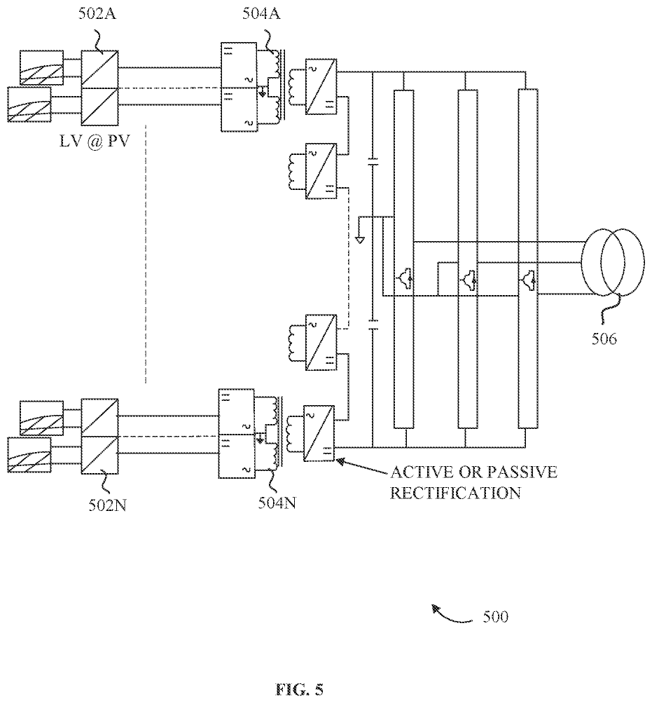

FIG. 5 is an exemplary diagram of a power conversion system 500 with a voltage source converter in accordance with an embodiment of the present disclosure. The exemplary diagram of the power conversion system 500 includes one or more Maximum Power Point Trackers (MPPT) DC-AC converters 502A-N, one or more solid state transformers 504A-N, and a bulk DC to AC converter interconnecting an electric grid 506. The one or more MPPT DC-AC converters 502A-N are connected with the one or more solid state transformers 504A-N. The one or more solid-state transformers 504A-N are connected with the electric grid 506 using the voltage source converter with active or passive rectification. In an embodiment, the voltage source converter is a medium voltage DC-AC inverter.

In an embodiment, the medium voltage DC-AC inverter is a modular multilevel converter or a voltage source converter.

In an embodiment, the medium voltage DC-AC inverter is configured to output medium voltage AC at a low frequency in a range of 50-60 Hz.

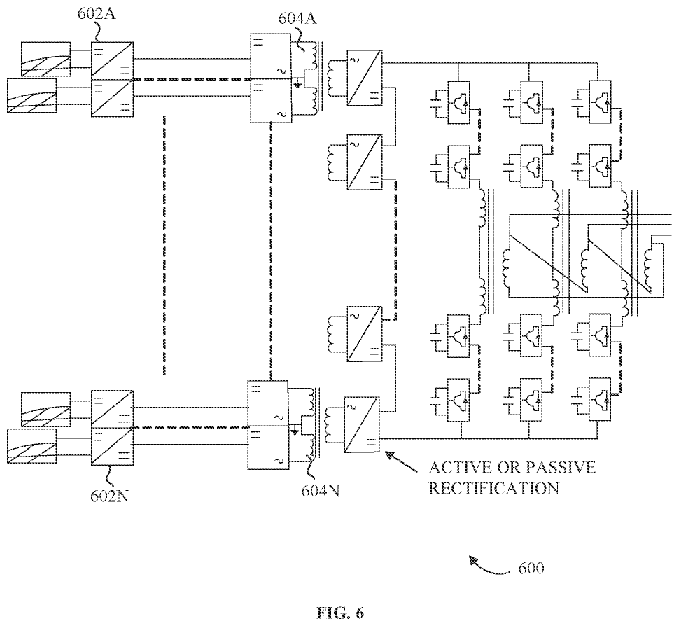

FIG. 6 is an exemplary diagram of a power conversion system 600 integrated with a Medium Voltage (MV) to High Voltage (HV) transformer in accordance with an embodiment of the present disclosure. The exemplary diagram of the power conversion system 600 includes one or more Maximum Power Point Trackers (MPPT) DC-AC converters 602A-N, and one or more solid state transformers 604A-N. The one or more MPPT DC-AC converters 602A-N are connected with the one or more solid state transformers 604A-N. The one or more solid-state transformers 604A-N are connected with an electric grid using a MV DC-AC inverter with active or passive rectification.

In an embodiment, the power conversion system 600 includes a low-frequency transformer configured to receive medium voltage AC power from the medium voltage DC-AC inverter and output high voltage AC power for supply to the electric grid.

In an embodiment, the low-frequency transformer is integrated with the medium voltage DC-AC inverter by combining one or more branch inductors in the inverter with one or more windings of the low-frequency transformer.

The power conversion system 600 reduces an amount of magnetics. Windings of the one or more solid state transformers 604A-N are replaced by one or more branch inductors that prevent leakages produced by the windings.

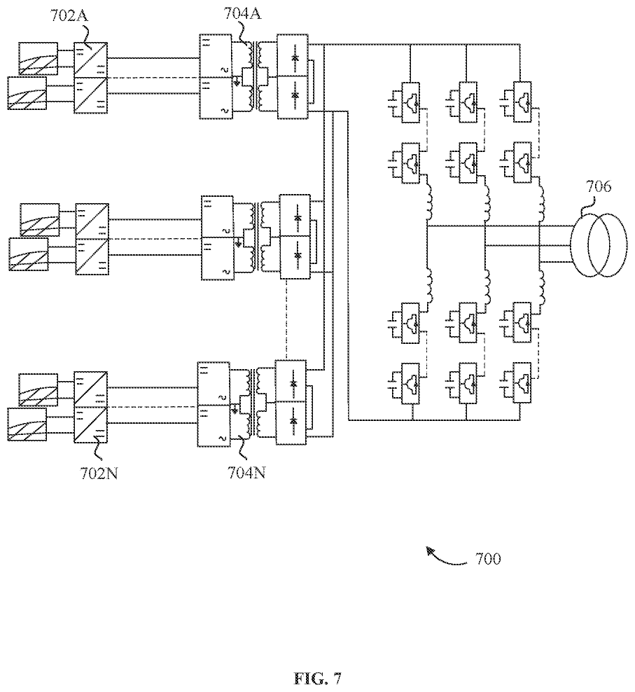

FIG. 7 is an exemplary diagram of a power conversion system 700 with one or more solid state transformers 704A-N that employs a passive rectifier in accordance with an embodiment of the present disclosure. The exemplary diagram of the power conversion system 700 includes one or more Maximum Power Point Trackers (MPPT) DC-AC converters 702A-N, the one or more solid state transformers 704A-N, and a bulk DC to AC converter interconnecting an electric grid 706. The one or more MPPT DC-AC converters 702A-N are connected with the one or more solid state transformers 704A-N. The one or more solid state transformers 704A-N are connected with the electric grid 706 using a MV DC-AC inverter after active or passive rectification. The active or passive rectification may be performed by an active rectifier or a passive rectifier.

A secondary stage of the one or more solid state transformers 704A-N is connected with AC-DC converters or the AC-DC rectifiers. The AC-DC rectifiers may be the passive rectifiers that aid in reducing a substantial cost over an option with active power semiconductors. The power conversion system 700 depicted in FIG. 7 provides simplified control and inherent higher ruggedness of diodes that may reduce cost reduction.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

1. A power conversion system, the power conversion system comprising:
a plurality of solid state transformers, each comprising:
a primary stage, the primary stage comprising at least one direct current-to-alternating current (DC-AC) converter arranged to receive low voltage direct current (DC) power from a power generator, and one or more primary medium frequency transformer windings; and
a secondary stage including at least one AC-DC rectifier each arranged to receive alternating current (AC) power from a respective secondary medium frequency transformer winding;
a medium voltage DC-AC inverter configured to receive medium voltage DC power from a plurality of AC-DC rectifiers and output medium voltage AC power.

2. The power conversion system of claim 1, wherein the secondary stage of each solid state transformer is configured to output the low voltage DC power, and an output of each of the AC-DC rectifiers in the plurality of solid state transformers is connected in series.

3. The power conversion system of claim 2, wherein summed output voltage of the AC-DC rectifiers is a medium voltage in a range of 20-50 kV.

4. The power conversion system of claim 1, wherein the secondary stage of each solid state transformer is configured to output the medium voltage DC power, and an output of each of the AC-DC rectifiers in the plurality of solid state transformers is connected in parallel.

5. The power conversion system of claim 1, wherein the low voltage DC power is less than about 1500V.

6. The power conversion system of claim 1, wherein each primary medium frequency transformer winding is connected to two DC-AC converters in a bipolar configuration.

7. The power conversion system of claim 1, further comprising a plurality of maximum power point trackers configured to connect each power generator to the corresponding DC-AC converter.

8. The power conversion system of claim 1, power generator comprises a photovoltaic power generator or a wind power generator.

9. The power conversion system of claim 1, wherein the medium frequency transformer windings of the plurality of solid state transformers are configured to operate at a medium frequency in a range of 2-20 kHz.

10. The power conversion system of claim 1, wherein any of the AC-DC rectifiers are active or passive rectifiers.

11. The power conversion system of claim 1, wherein the medium voltage DC-AC inverter is a modular multilevel converter or a voltage source converter.

12. The power conversion system of claim 1, wherein the medium voltage DC-AC inverter is configured to output the medium voltage AC power at a low frequency in a range of 50-60 Hz.

13. The power conversion system of claim 1, further comprising a low-frequency transformer configured to receive the medium voltage AC power from the medium voltage DC-AC inverter and output a high voltage AC power for supply to an electric grid.

14. The power conversion system of claim 13, wherein the low-frequency transformer is integrated with the medium voltage DC-AC inverter by combining one or more branch inductors in the medium voltage DC-AC inverter with one or more windings of the low-frequency transformer.

15. The power conversion system of claim 2, wherein the low voltage DC power is less than about 1500V.

16. The power conversion system of claim 2, wherein each primary medium frequency transformer winding is connected to two DC-AC converters in a bipolar configuration.

17. The power conversion system of claim 2, further comprising a plurality of maximum power point trackers configured to connect each power generation unit to the corresponding DC-AC converter.

18. The power conversion system of claim 2, wherein each power generator comprises a photovoltaic power generator or a wind power generator.

19. The power conversion system of claim 2, wherein the medium frequency transformer windings of the plurality of solid state transformers are configured to operate at a medium frequency in a range of 2-20 KHz.

20. The power conversion system of claim 2, wherein any of the AC-DC rectifiers are active or passive rectifiers.
